(19) United States
(12) Patent Application Publication
(10) Pub. No.: US 2025/0221886 A1
(43) Pub. Date: Jul. 10, 2025

(54) VIBRATING SEXUAL STIMULATION DEVICE

(71) Applicant: MysteryVibe Limited, Surrey (GB)

(72) Inventors: Robert Paul WEEKLY, Haslemere (GB); Soumyadip RAKSHIT, London (GB); Shanshan XU, London (GB); David Ian HEYWOOD, Surrey (GB)

(73) Assignee: MysteryVibe Limited, Surrey (GB)

(21) Appl. No.: 18/853,598

(22) PCT Filed: Apr. 7, 2023
(86) PCT No.: PCT/IB2023/053591

§ 371 Date: Oct. 2, 2024

Related U.S. Application Data
(63) Continuation-in-part of application No. 29/853,925, filed on Sep. 20, 2022, now Pat. No. D026242.
(60) Provisional application No. 63/329,316, filed on Apr. 8, 2022.

(30) Foreign Application Priority Data
May 30, 2022 (GB) 6211354
May 31, 2022 (EM) 009048200-0003

(51) Int. Cl. A61H 19/00; A61H 23/02

(52) U.S. Cl. CPC A61H 19/34; A61H 19/32; A61H 19/50; A61H 23/0263; A61H 2023/0272; A61H 2201/0157; A61H 2201/0192; A61H 2201/1207; A61H 2201/5005; A61H 2201/5035; A61H 2201/5038; A61H 2201/5097

(57) ABSTRACT

Vibrating devices or sexual stimulation devices according to various embodiments are provided. In some embodiments, the device has a ring-shaped structure and includes at least one motor configured to generate vibration. an internal structure housing the at least one motor, and a deformable outer ring enclosing the internal structure. In some embodiments, the device includes a main body, a first segment and a fourth segment flexibly or rotatably coupled to the main body, a second segment flexibly or rotatably coupled to the first segment, and a third segment flexibly or rotatably coupled to the fourth segment. The first, second, third, and fourth segments form an adjustable ring structure having a central gap exposing at least a vaginal opening of a user when the device is placed on labia of the user. In some embodiments, each of the first, second, third, and fourth segments has a motor configured to generate vibration.

### CROSS-REFERENCE TO RELATED APPLICATIONS

This application includes a claim of priority under 35 U.S.C. § 119(e) to U.S. provisional patent application No. 63/329,316, filed Apr. 8, 2022, and a claim of priority under 35 U.S.C. § 120 to U.S. design patent application Ser. No. 29/853,925, filed Sep. 20, 2022, claiming priority under 35 U.S.C. § 119(a) and 172 to United Kingdom Design Application No. 6211354, filed May 30, 2022, and European Registered Community Design (RCD) application Ser. No. 00/904,8200-0003, filed May 31, 2022, the entirety of which is hereby incorporated by reference.

### FIELD OF INVENTION

The present invention relates to a vibrating device used for stimulation of female sexual organs.

### BACKGROUND

Arousal disorder is very common. Over 35% of women suffer from it. As a result, it can lead to an unfulfilled sex life, loss of intimacy, strained relationship, depression, anxiety and low self-esteem. Currently, the main solutions for arousal disorder are medicinal like estrogen therapy. However, not all users qualify to take them and they often have adverse side effects. Therefore, many users are limited to a certain maximum number they can take it a month. Moreover, estrogen therapy is expensive as users need to take them regularly. Current vibrations-based solutions focus on internal vaginal stimulation and/or direct clitoral stimulation. However, most women cannot orgasm from internal vaginal stimulation alone. Additionally, many women experience penetration pain, so they are unable to insert fingers or devices to stimulate themselves internally. Further, many women have sensitive clitoris, making it painful to stimulate clitoris.

Therefore, there is a large unmet need to provide safer and cheaper solution for treatment of arousal disorder. Described herein is a device which offers an alternative solution for arousal disorder by delivering 360 vibrations all around the labia and help create rapid arousal and lubrication. The inventive device can be used as many times as a user wants once the user obtains the device, providing a much better user experience than estrogen therapy.

### SUMMARY OF THE INVENTION

The present disclosure provides a sexual stimulation device having a ring-shaped structure. According to various embodiments of the present invention, the sexual stimulation device includes at least one motor configured to generate vibration, an internal structure housing the at least one motor, and a deformable outer ring enclosing the internal structure.

In some embodiments, the outer ring is made of a flexible material. In some embodiments, a shape of the ring is changeable.

In some embodiments, a central gap is formed in the middle of the ring and a size of the central gap is adjustable to fit labia of a user. In some embodiments, the size of the central gap is adjusted such that the sexual stimulation device is placed mainly on outer labia, labia majora, or outer lips of the labia, exposing all or most of inner labia, labia minora, or inner lips of the labia through the central gap.

In some embodiments, the at least one motor includes a first motor provided at a first portion of the ring-shaped structure, a second motor provided at a second portion of the ring-shaped structure, a third motor provided at a third portion of the ring-shaped structure, and a fourth motor provided at a fourth portion of the ring-shaped structure. Labia of a user are stimulated simultaneously by vibrations generated by the first, second, third, and fourth motors. In some embodiments, each of the first, second, third, and fourth motors is individually controllable.

In some embodiments, the device is configured to provide various preset vibration patterns such that a user can select a desired one of the preset vibration patterns. In some embodiments, the preset vibration patterns programmable by a user. In some embodiments, the device is controllable via an application running on a mobile device that is configured to communicate with the device wirelessly.

The present disclosure also provides a device. According to various embodiments of the present invention, the device includes a main body; a first segment and a fourth segment flexibly or rotatably coupled to the main body; a second segment flexibly or rotatably coupled to the first segment; and a third segment flexibly or rotatably coupled to the fourth segment. The first, second, third, and fourth segments form an adjustable ring structure having a central gap exposing at least a vaginal opening of a user when the device is placed on labia of the user.

In some embodiments, each of the first, second, third, and fourth segments is curved.

In some embodiments, when the device is placed on the labia of the user, the main body is configured to contact a clitoris of the user; the central gap further exposes a urethral opening of the user; and vibration generated by the device stimulates at least the labia.

In some embodiments, a size of the central gap is changeable by moving at least one of the first, second, third, and fourth segments to fit a size of the labia. In some embodiments, each of the first, second, third, and fourth segments has a motor configured to generate vibration.

In some embodiments, the device further includes an input unit provided on the main body, the input unit configured to receive user input for powering on/off the device and/or controlling vibration intensity and/or pattern. In some embodiments, the vibration intensity and/or pattern of each motor is adjustable and/or programmable.

The present disclosure also provides a device. According to various embodiments of the present invention, the device includes a main body having an input unit configure to receive user input; a first segment and a fourth segment flexibly or rotatably coupled to the main body; a second segment flexibly or rotatably coupled to the first segment; and a third segment flexibly or rotatably coupled to the fourth segment. Each of the first, second, third, and fourth segments has a motor configured to generate vibration.

In some embodiments, the first, second, third, and fourth segments form an adjustable ring structure having a central gap exposing at least a vaginal opening of a user when the device is placed on labia of the user.

In some embodiments, a gap is formed between the second segment and the third segment of an internal structure that is housed in a deformable outer ring such that the gap is not visible externally.

The present disclosure also provides a method of treating female sexual arousal disorder using a vibrating device. According to various embodiments of the present invention, the method includes adjusting the flexible vibrating device to match a user's labia's shape and size; placing the adjusted vibrating device on the labia for maximum surface area contact; and causing the placed vibrating device to apply vibration generated by a plurality of motors of the vibrating device around the labia.

The present disclosure also provides a method of stimulating a female sexual organ externally using a vibrating device. According to various embodiments of the present invention, the method includes adjusting the flexible vibrating device to match a user's labia's shape and size; placing the adjusted vibrating device on the labia for maximum surface area contact; and causing the placed vibrating device to apply vibration generated by a plurality of motors of the vibrating device around the labia.

The present disclosure also provides a method of rapidly arousing and lubricating a female sexual organ using a vibrating device. According to various embodiments of the present invention, the method includes adjusting the flexible vibrating device to match a user's labia's shape and size; placing the adjusted vibrating device on the labia for maximum surface area contact; and causing the placed vibrating device to apply vibration generated by a plurality of motors of the vibrating device around the labia.

In some embodiments, the method further includes applying a penis, finger, or penetrating device through an opening or central gap of the vibrating device for internal vaginal stimulation.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 shows a front perspective view of a vibrating device in accordance with various embodiments of the present invention.

FIG. 2 shows an exploded view of an internal structure of a vibrating device in accordance with various embodiments of the present invention.

FIGS. 3A, 3B, and 3C show the internal structure of a deformable vibrating device in various shapes in accordance with various embodiments of the present invention.

FIGS. 4A, 4B, and 4C show the external appearance of the deformable vibrating device shown in FIGS. 3A, 3B, and 3C, respectively, in accordance with various embodiments of the present invention.

FIG. 5A shows female sexual anatomy. FIG. 5B shows a vibrating device in accordance with various embodiments of the present invention worn on the external part of the female genital.

FIG. 6A is a front view of a vibrating device in accordance with various embodiments of the present invention.

FIG. 6B is a right side view of a vibrating device in accordance with various embodiments of the present invention.

FIG. 6C is a rear view of a vibrating device in accordance with various embodiments of the present invention.

FIG. 6D is a left side view of a vibrating device in accordance with various embodiments of the present invention.

FIG. 6E is a top view of a vibrating device in accordance with various embodiments of the present invention.

FIG. 6F is a bottom perspective view of a vibrating device in accordance with various embodiments of the present invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

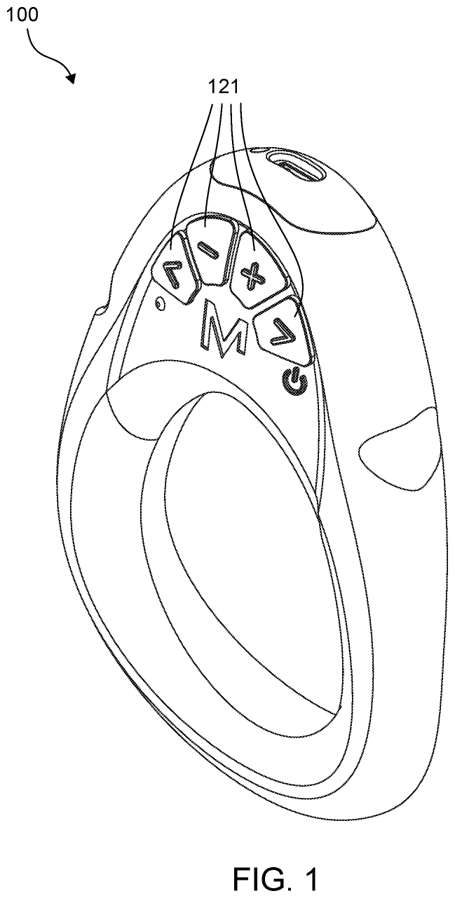

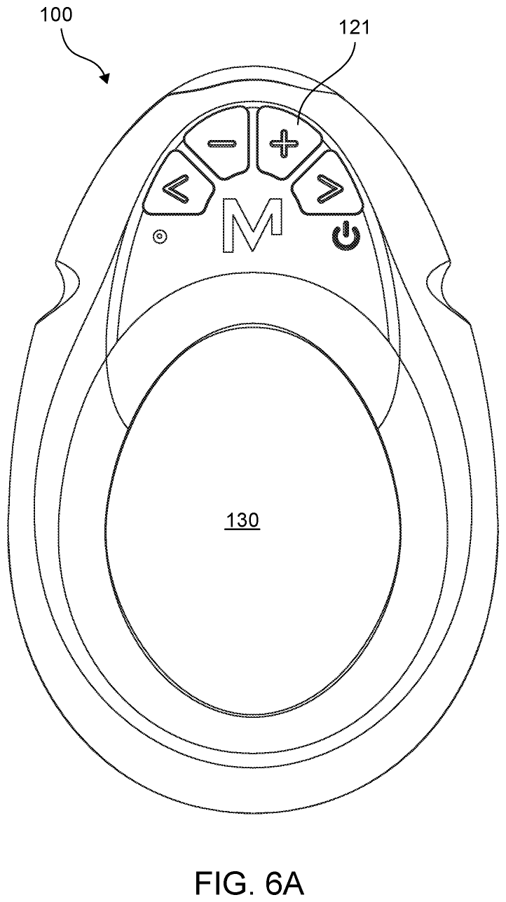

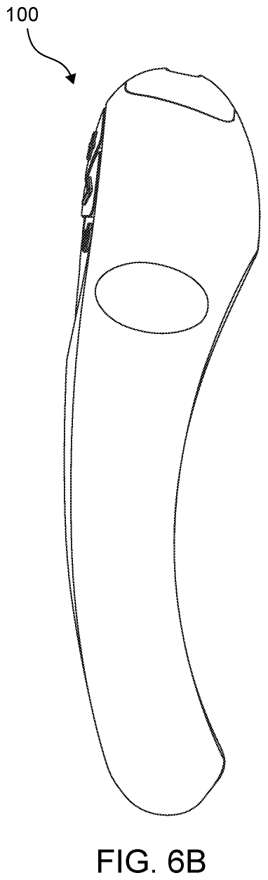

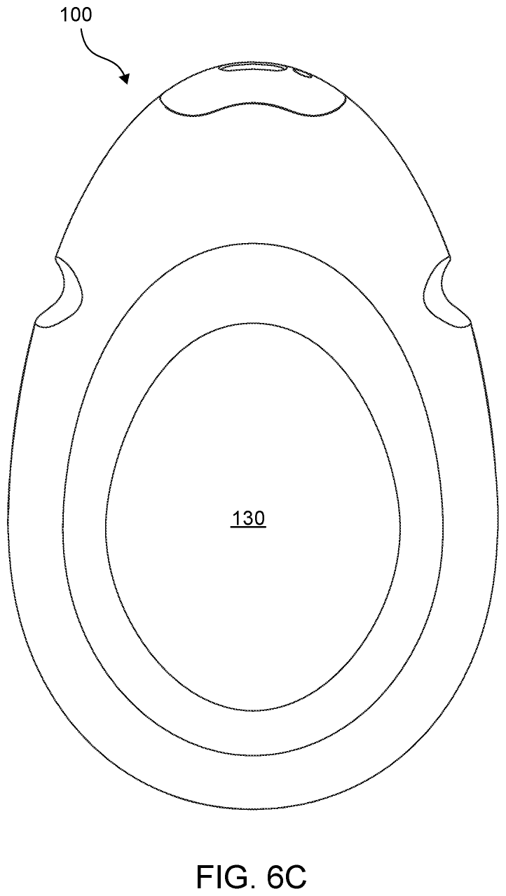

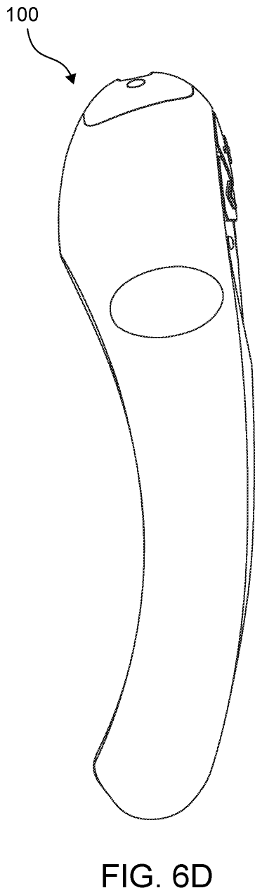

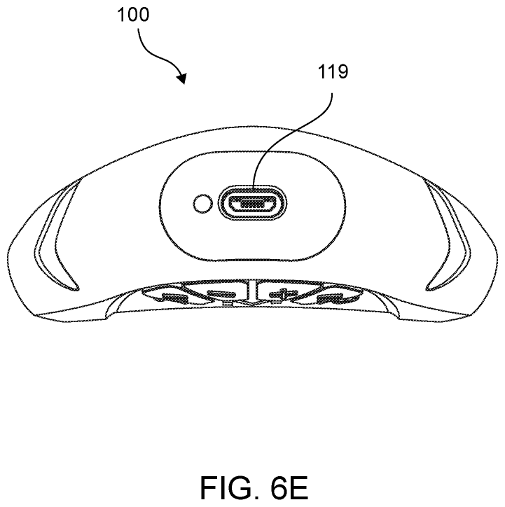

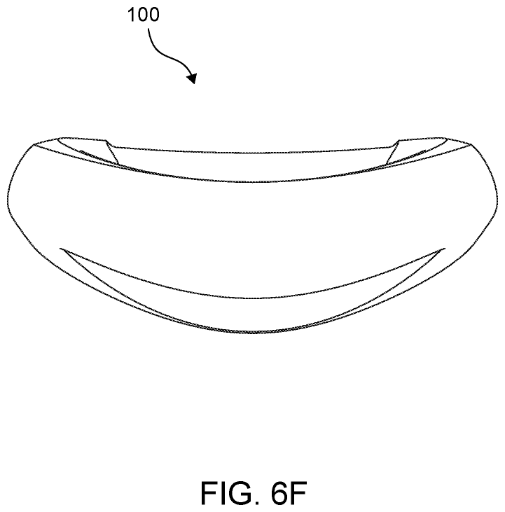

The various embodiments are directed to a vibrating device 100 or sexual stimulation device for female sexual organs, as exemplified in FIGS. 1 and 6A-6F. In particular, the adaptable vibrating device 100 assists with arousal through external stimulation of the female sexual organs. For example, a user who has dryness due to menopause or other reasons can use the vibrating device 100 for full external stimulation all over the labia and vulva to get aroused and wet. Further, a user who has arousal disorder or general difficulty with getting aroused can use the vibrating device 100 for full external stimulation without needing to insert anything.

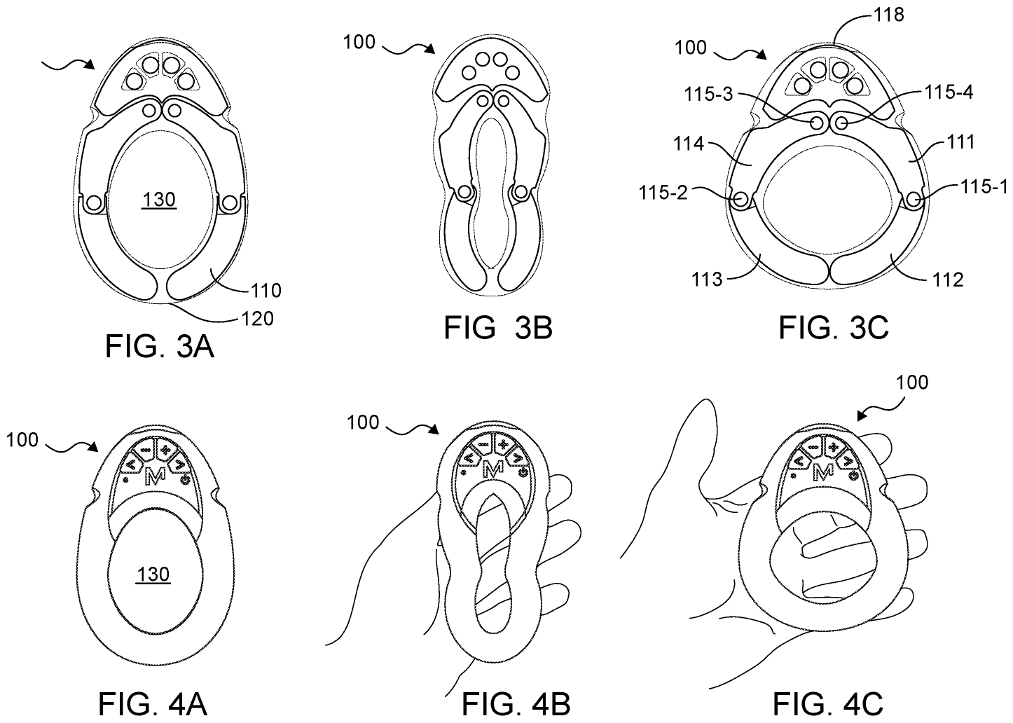

For example, the device 100 is ring-shaped, having an opening or central gap 130. The device 100 is deformable, bendable or flexible to be adjusted to match the user's labia's shape and size. Thus, the shape of the central gap 130 is also changeable according to the changed shape of the device 100. For example, see FIGS. 3A-4C showing the device 100 in various shapes.

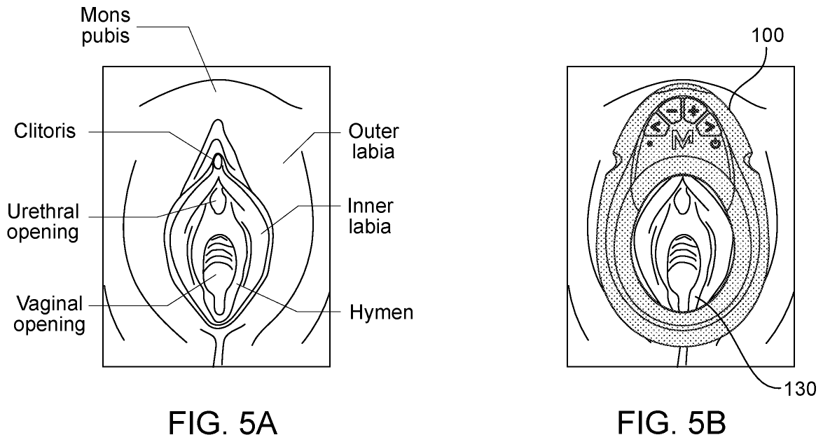

Referring to FIG. 5A, the labia (lips) are folds of skin around the vaginal opening. The labia majora/outer labia (outer lips) are usually fleshy and covered with pubic hair. The labia minora/inner labia (inner lips) are inside the outer lips. The labia begin at the clitoris and end under the opening to the vagina. A key element to female arousal is external stimulation, particularly around the labia. To create maximum arousal, vibration needs to be delivered across the maximum surface area around the labia. However, every woman's vulva and labia are unique in shape and size.

To achieve maximum surface area coverage for maximum stimulation, the device 100 needs to be flexible on all sides, for example, four sides, i.e., left, right, top, and bottom. Further, the device 100 should hold the shape adjusted to match the user's labia. Thus, the device 100 is composed of multiple segments to accommodate the adjustment of the shape.

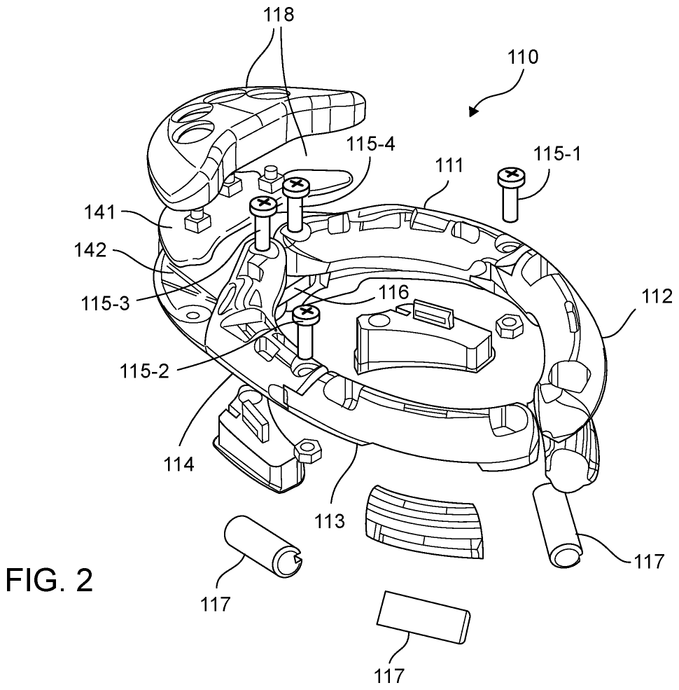

For example, referring to FIG. 2, the device 100 includes four segments 111, 112, 113, 114 that are coupled to each other by a coupling/hinge mechanism. For example, the four segments 111, 112, 113, 114 are flexibly coupled to each other by coupling means such as screws 115-1, 115-2, 115-3, 115-4, as exemplified in FIG. 2. However, the coupling means is not limited thereto, and may be implemented as other mechanisms such as pins.

Referring to FIGS. 1 and 2, in some embodiments, the vibrating device 100 has a main body 118 or top, a first segment 111 and a fourth segment 114 coupled to the main body, a second segment 112 coupled to the first segment, and a third segment 113 coupled to the fourth segment. The first through fourth segments 111, 112, 113, 114 form a ring structure of the device 100. That is, a hole or central gap 130 is formed by the first through fourth segments 111, 112, 113, 114 without requiring the main body 118 for formation of the central gap. See the upper panel of FIG. 2B.

In some embodiments, the first segment 111 and the second segment 112 are coupled to each other directly. That is, as exemplified in FIG. 2, a first end portion of the first segment 111 is rotatably coupled directly to a first end portion of the second segment 112, a first screw 115-1 passing through the first end portion of the first segment and the first end portion of the second segment. However, the coupling configuration/mechanism for the first segment 111 and the second segment 112 is not limited thereto, and the first segment and the second segment may be coupled indirectly via a coupling portion, the first end portion of the first segment being rotatably coupled to a first portion of the coupling portion and the first end portion of the second segment being rotatably coupled to a second portion of the coupling portion. Thus, the second segment 112 is movable with respect to the first segment 111.

In various embodiments, the second segment 112 and the third segment 113 are not coupled, as exemplified in FIGS. 3A-3C. Thus, a gap is formed between a second end portion of the second segment 112 and a first end portion of the third segment 113, as shown in FIGS. 3A-3C. Further, the size of the gap or the distance between the second end portion of the second segment 112 and the first end portion of the third segment 113 is changeable according to the movement of the second segment 112 and/or the third segment 113 causing change of the shape of the device 100.

In other embodiments, the second end portion of the second segment 112 is rotatably coupled directly to the first end portion of the third segment 113, a coupling means or screw passing through the second end portion of the second segment and the first end portion of the third segment. In alternative embodiments, the second segment 112 and the third segment 113 are coupled indirectly via a coupling portion, the second end portion of the second segment being rotatably coupled to a first portion of the coupling portion and the first end portion of the third segment being rotatably coupled to a second portion of the coupling portion.

As discussed above, when the second segment 112 and the third segment 113 are not coupled, as exemplified in FIGS. 2-3C, the second end portion of the second segment is not in contact with the first end portion of the third segment. However, in other embodiments, even when the second segment 112 and the third segment 113 are not coupled, the second end portion of the second segment contacts or is capable of contacting the first end portion of the third segment by moving the second segment and/or third segment.

Further, as shown in FIG. 2, the third segment 113 and the fourth segment 114 are coupled to each other directly. That is, as exemplified in FIG. 2, a second end portion of the third segment 113 is rotatably coupled directly to a first end portion of the fourth segment 114, a second screw 115-2 passing through the second end portion of the third segment and the first end portion of the fourth segment. However, the coupling configuration/mechanism for the third segment 113 and the fourth segment 114 is not limited thereto, and the third segment and the fourth segment may be coupled indirectly via a coupling portion, the second end portion of the third segment being rotatably coupled to a first portion of the coupling portion and the first end portion of the fourth segment being rotatably coupled to a second portion of the coupling portion.

Furthermore, as shown in FIG. 2, the fourth segment 114 and the first segment 111 are coupled to each other indirectly. That is, as exemplified in FIG. 2, the fourth segment 114 and the first segment 111 are coupled via a coupling portion 116, a second end portion of the fourth segment being rotatably coupled to a first portion of the coupling portion and a second end portion of the first segment being rotatably coupled to a second portion of the coupling portion. Referring to FIG. 2, a third screw 115-3 passes through the second end portion of the fourth segment 114 and the first portion of the coupling portion 116, and a fourth screw 115-4 passes through the second end portion of the first segment 111 and the second portion of the coupling portion. However, the coupling configuration/mechanism for the fourth segment 114 and the first segment 111 is not limited thereto, and the fourth segment and the first segment may be coupled to each other directly similar to the coupling configuration/mechanism for the first segment and the second segment 112 and the coupling configuration/mechanism for the third segment 113 and the fourth segment exemplified in FIG. 2.

Due to the flexibility and movability of the four segments 111, 112, 113, 114 of the device 100, the shape of the device can be changed easily with hands, as shown in FIGS. 4A-4C. That is, the device 100 can be flexed in four ways to precisely adapt to the vulva and labia shape of the user. For example, the device 100 can be adjusted to have the shapes exemplified in FIGS. 4A-4C although the shapes are not limited thereto. Further, the distance between the first screw 115-1 and the second screw 115-2 can be increased or decreased based on the shape of the device 100 and/or according to the movement(s) of the first, second, third, and/or fourth segments 111, 112, 113, 114.

Referring to FIG. 2, each segment 111, 112, 113, 114 contains a vibration motor 117. Thus, the device 100 contains four vibration motors 117 total. However, the number of the vibration motors 117 is not limited thereto and the number may be less than or greater than four. In some embodiments, the main body 118 of the device 100 also includes an additional vibration motor although it is not shown in the embodiment exemplified in the drawings.

For example, the device 100 can be flexed in four ways to precisely adapt to the vulva and labia shape of the user. At the same time, the hinges or coupling mechanism coupling or connecting the segments 111, 112, 113, 114 have the exact amount of friction to allow them to be bent easily and at the same time hold its shape under pressure during use.

Once the shape of the device 100 is adjusted, then the adjusted device is placed on the labia for maximum surface area contact to deliver 360° stimulations around it. This results in increased blood flow to the labia and vulva leading to arousal and lubrication. The vulva is the part of genitals on the outside of the body-labia, clitoris, vaginal opening, and the urethral opening. See FIG. 5A. In some embodiments, the top portion or main body 118 of the device 100 is placed on the clitoris or in contact with the clitoris such that the clitoris is also stimulated by the vibration. In this case, the clitoris is not exposed through the central gap 130 of the device. However, depending on the adjusted shape of the device 100, the clitoris may also be exposed through the central gap 130 of the device.

When the device 100 is placed on the labia, at least the urethral opening and the vaginal opening are exposed through the central gap 130 of the device, as shown in FIG. 5B. In some embodiments, the inner labia are also exposed through the central gap 130 of the device 100 when the device is placed mainly on the outer labia, as exemplified in FIG. 5B. Once the device 100 is placed on the labia, as shown in FIG. 5B, the central gap 130 or opening of the device can then be opened wide due to the vibration stimulation to allow penetrative sex or additional internal vaginal stimulation by fingers or a secondary device such as vibrator.

FIGS. 3A-3C show the internal structure 110 of the device 100 enclosed in the outer ring 120 while FIGS. 4A-4C show pictures of the actual device in which only the outer ring 120 is shown. The device 100's dynamic bendable outer ring 120 with friction hold hinges uses bespoke pre-conditioned nylon material for form recovery and flexibility. In some embodiments, the outer ring 120 is made of silicone. In some embodiments, the device 100 is waterproof.

The internal structure 110 of the device 100 houses electronics such as a circuit board 141, a battery 142, and vibration motors 117. In some embodiments, although vibration motors 117 are housed in the first through fourth segments 111, 112, 113, 114, most electronics and battery 142 are housed in the main body 118. In some embodiments, the device 100 is designed with three integrated friction hinges allowing the profile of the outer ring 120 to be bent and adapt to best fit the user's labia. The friction in the hinges is set precisely so as to allow it to be bent easily, and at the same time be strong enough to hold onto that bent shape while in use. For example, the diameter of the central gap 130 from top to bottom is up to 3 inches, thus accommodating over 90% of labia.

In various embodiments, four targeted vibration motors 117 are incorporated into the ring structure of the device 100 formed by the segments 111, 112, 113, 114, two being located on each side, to deliver precise vibration all over the labia. Thus, all the external erogenous zones, including labia, vulva, and clitoris, can be stimulated at the same time. This unique design profile also allows the user to insert to not only adapt the device 100 to their body, but also insert a device, fingers or have intercourse through the central gap 130 while using the device.

Referring to FIG. 2, the vibrating device 100 includes vibration motors, for example four motors 117 (only three are shown in the drawing). The vibrating device 100 further includes a rechargeable battery 142 that powers the device. In some embodiment, the battery is located in the main body 118. For example, the battery is a built-in lithium-ion battery. In some embodiments, the battery 142 is rechargeable via a port 119 of the device 100 and operably coupled to the circuit board 141 and/or motors 117, as shown in FIG. 6E. For example, the port 119 is located at the top or main body 118 of the device 100 shown in FIGS. 1 and 6E. For example, the port 119 is a Universal Serial Bus (USB) port including micro USB, USB-A, USB-B, and USB-C Port Types. The charged battery 142 provides power to operate the motors 117. In some embodiments, the battery 142 is rechargeable wirelessly by a wireless charger such as a wireless charging pad.

In some embodiments, the vibrating device 100 further includes an input unit or switch 121. The vibrating device 100 has one, two, or multiple switches based on the design. For example, the vibrating device 100 is provided with four input buttons 121 on the upper surface of the device or main body 118, as shown in FIGS. 1 and 2. These input buttons 121 provide functions such as power on/off, vibration pattern navigation, intensity adjustment and BLUETOOTH® pairing. For example, the vibrating device 100 is turned by pressing and holding one of the input buttons 121 designated as a power on/off switch. In some embodiments, two directional buttons 121, for example <and>, are pressed to cycle through the vibes or vibration patterns. In some embodiments, two of the buttons 121, for example + and −, are pressed to change (increase/decrease) the intensity of vibration. For example, there are 5, 10, 15, or more than 15 intensities are available for selection.

In some embodiments, the vibrating device 100 has a wireless communication component and is paired with a mobile device to be controlled by the mobile device. For example, a mobile application or app, i.e., a computer program or software application, is run on the mobile device to control the vibrating device 100 via the mobile application. Furthermore, the vibration program of the vibrating device 100 can be customized as the user progresses through the session by applying the exact amount of stimulation by live-controlling the power with the app.

In some embodiments, each of the multiple motors, for example four motors 117, can be individually controlled. Further, various vibration patterns generated by the motors 117 can be selected or set by a user. For example, a vibration pattern can consist of up to set minutes (for example 1, 2, 3, 4, or 5 minutes) of unique pattern sequencing of the motors 117 before repeating. Vibration patterns are either pre-programmed on the circuit board 141 of the vibrating device 100 or by using the user's mobile device or smart phone to remotely control the motors 117.

Users can create their own vibration patterns utilising the app available for the vibrating device 100. For example, the app is available on Google Play and Apple App stores. Once created, these vibration patterns can be loaded onto the vibrating device 100 for use in standalone operation mode.

Referring to FIGS. 5A and 5B, in some embodiments, a method of treating female sexual arousal disorder using the vibrating device 100 includes adjusting the device to match the user's labia's shape and size, placing the adjusted device on the labia for maximum surface area contact (to increase blood flow to the labia and vulva, leading to arousal and lubrication), and causing the placed device to apply vibration generated by the device around the labia. The method allows the aroused vulva/labia to receive a penetrating finger or device for internal vaginal stimulation. In some embodiments, a lubricant is applied to the vibrating device 100 prior to being placed on the labia. After using the vibrating device 100, it can be washed with a toy cleaner or soap and water.

Further referring to FIGS. 5A and 5B, in some embodiments, a method of stimulating a female sexual organ externally using the vibrating device 100 includes adjusting the device to match the user's labia's shape and size, placing the adjusted device on the labia for maximum surface area contact (to increase blood flow to the labia and vulva, leading to arousal and lubrication), and causing the placed device to apply vibration generated by the device around the labia. The method allows the aroused vulva/labia to receive a penetrating finger or device for internal vaginal stimulation without requiring direct internal vaginal stimulation and/or clitoral stimulation.

Further referring to FIGS. 5A and 5B, in some embodiments, a method of rapidly arousing and lubricating a female sexual organ using the vibrating device 100 includes adjusting the device to match the user's labia's shape and size, placing the adjusted device on the labia for maximum surface area contact (to increase blood flow to the labia and vulva, leading to arousal and lubrication), and causing the placed device to apply vibration generated by the device around the labia. The method allows the aroused/lubricated vulva/labia/vagina to receive a penetrating finger or device for internal vaginal stimulation without requiring direct internal vaginal stimulation and/or clitoral stimulation prior to the penetration.

According to various embodiments of the present disclosure, a sexual stimulation device having a ring-shaped structure includes at least one motor configured to generate vibration; an internal structure housing the at least one motor; and a deformable outer ring enclosing the internal structure.

According to some embodiments of the present disclosure, the outer ring is made of a flexible material. In some embodiments, the outer ring is made of silicone. In some embodiments, a shape of the ring is changeable. In some embodiments, a central gap is formed in the middle of the ring and a size of the central gap is adjustable to fit labia of a user. In some embodiments, the size of the central gap is adjusted such that the sexual stimulation device is placed mainly on outer labia, labia majora, or outer lips of the labia, exposing all or most of inner labia, labia minora, or inner lips of the labia through the central gap. In some embodiments, the at least one motor includes a first motor provided at a first portion of the ring-shaped structure; a second motor provided at a second portion of the ring-shaped structure; a third motor provided at a third portion of the ring-shaped structure; and a fourth motor provided at a fourth portion of the ring-shaped structure, such that labia of a user are stimulated simultaneously by vibrations generated by the first, second, third, and fourth motors. In some embodiments, each of the first, second, third, and fourth motors is individually controllable. In some embodiments, the device is configured to provide various preset vibration patterns such that a user can select a desired one of the preset vibration patterns. In some embodiments, the preset vibration patterns programmable by a user. In some embodiments, the device is controllable via an application running on a mobile device that is configured to communicate with the device wirelessly.

According to various embodiments of the present disclosure, a device includes a main body; a first segment and a fourth segment flexibly or rotatably coupled to the main body; a second segment flexibly or rotatably coupled to the first segment; and a third segment flexibly or rotatably coupled to the fourth segment. The first, second, third, and fourth segments form an adjustable ring structure having a central gap exposing at least a vaginal opening of a user when the device is placed on labia of the user.

According to some embodiments of the present disclosure, each of the first, second, third, and fourth segments is curved. In some embodiments, when the device is placed on the labia of the user: the main body is configured to contact a clitoris of the user; the central gap further exposes a urethral opening of the user; and vibration generated by the device stimulates at least the labia. In some embodiments, a size of the central gap is changeable by moving at least one of the first, second, third, and fourth segments to fit a size of the labia. In some embodiments, each of the first, second, third, and fourth segments has a motor configured to generate vibration. In some embodiments, the device further includes an input unit provided on the main body, the input unit configured to receive user input for powering on/off the device and/or controlling vibration intensity and/or pattern. In some embodiments, the vibration intensity and/or pattern of each motor is adjustable and/or programmable.

According to various embodiments of the present disclosure, a device includes a main body having an input unit configure to receive user input; a first segment and a fourth segment flexibly or rotatably coupled to the main body; a second segment flexibly or rotatably coupled to the first segment; and a third segment flexibly or rotatably coupled to the fourth segment. Each of the first, second, third, and fourth segments has a motor configured to generate vibration.

According to some embodiments of the present disclosure, the first, second, third, and fourth segments form an adjustable ring structure having a central gap exposing at least a vaginal opening of a user when the device is placed on labia of the user. In some embodiments, a gap is formed between the second segment and the third segment of an internal structure that is housed in a deformable outer ring such that the gap is not visible externally.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A sexual stimulation device having a ring-shaped structure, the sexual stimulation device comprising:
at least one motor configured to generate vibration;
an internal structure housing the at least one motor; and
a deformable outer ring enclosing the internal structure.

2. The sexual stimulation device according to claim 1, wherein the outer ring is made of a flexible material.

3. The sexual stimulation device according to claim 1, wherein a shape of the ring is changeable.

4. The sexual stimulation device according to claim 1, wherein a central gap is formed in the middle of the ring and a size of the central gap is adjustable to fit labia of a user.

5. The sexual stimulation device according to claim 4, wherein the size of the central gap is adjusted such that the sexual stimulation device is placed mainly on outer labia, labia majora, or outer lips of the labia, exposing all or most of inner labia, labia minora, or inner lips of the labia through the central gap.

6. The sexual stimulation device according to claim 1, wherein the at least one motor comprises:
a first motor provided at a first portion of the ring-shaped structure;
a second motor provided at a second portion of the ring-shaped structure;
a third motor provided at a third portion of the ring-shaped structure; and
a fourth motor provided at a fourth portion of the ring-shaped structure,
such that labia of a user are stimulated simultaneously by vibrations generated by the first, second, third, and fourth motors.

7. The sexual stimulation device according to claim 6, wherein each of the first, second, third, and fourth motors is individually controllable.

8. The sexual stimulation device according to claim 1, wherein the device is configured to provide various preset vibration patterns such that a user can select a desired one of the preset vibration patterns.

9. The sexual stimulation device according to claim 8, wherein the preset vibration patterns programmable by a user.

10. The sexual stimulation device according to claim 1, wherein the device is controllable via an application running on a mobile device that is configured to communicate with the device wirelessly.

11. A device comprising:
a main body;
a first segment and a fourth segment flexibly or rotatably coupled to the main body;
a second segment flexibly or rotatably coupled to the first segment; and
a third segment flexibly or rotatably coupled to the fourth segment,
wherein the first, second, third, and fourth segments form an adjustable ring structure having a central gap exposing at least a vaginal opening of a user when the device is placed on labia of the user.

12. The device according to claim 11, wherein each of the first, second, third, and fourth segments is curved.

13. The device according to claim 11, wherein when the device is placed on the labia of the user:
the main body is configured to contact a clitoris of the user;
the central gap further exposes a urethral opening of the user; and
vibration generated by the device stimulates at least the labia.

14. The device according to claim 11, wherein a size of the central gap is changeable by moving at least one of the first, second, third, and fourth segments to fit a size of the labia.

15. The device according to claim 11, wherein each of the first, second, third, and fourth segments has a motor configured to generate vibration.

16. The device according to claim 15, further comprising an input unit provided on the main body, the input unit configured to receive user input for powering on/off the device and/or controlling vibration intensity and/or pattern.

17. The device according to claim 16, wherein the vibration intensity and/or pattern of each motor is adjustable and/or programmable.

18. A device comprising:
a main body having an input unit configure to receive user input;
a first segment and a fourth segment flexibly or rotatably coupled to the main body;
a second segment flexibly or rotatably coupled to the first segment; and
a third segment flexibly or rotatably coupled to the fourth segment,
wherein each of the first, second, third, and fourth segments has a motor configured to generate vibration.

19. The device according to claim 18, wherein the first, second, third, and fourth segments form an adjustable ring structure having a central gap exposing at least a vaginal opening of a user when the device is placed on labia of the user.

20. The device according to claim 19, wherein a gap is formed between the second segment and the third segment of an internal structure that is housed in a deformable outer ring such that the gap is not visible externally.

21. A method of treating female sexual arousal disorder using the sexual stimulation device of claim 1, the method comprising:
adjusting the flexible sexual stimulation device to match a user's labia's shape and size;
placing the adjusted sexual stimulation device on the labia for maximum surface area contact; and
causing the placed sexual stimulation device to apply vibration generated by the at least one motor around the labia.

22. A method of stimulating a female sexual organ externally using the sexual stimulation device of claim 1, the method comprising:
adjusting the flexible sexual stimulation device to match a user's labia's shape and size;
placing the adjusted sexual stimulation device on the labia for maximum surface area contact; and
causing the placed sexual stimulation device to apply vibration generated by a the at least one motor around the labia.

23. A method of rapidly arousing and lubricating a female sexual organ using the sexual stimulation device of claim 1, the method comprising:
adjusting the flexible sexual stimulation device to match a user's labia's shape and size;
placing the adjusted sexual stimulation device on the labia for maximum surface area contact; and
causing the placed sexual stimulation device to apply vibration generated by a the at least one motor around the labia.

24. The method of claim 23, further comprising applying a penis, finger, or penetrating device through an opening or central gap of the sexual stimulation device for internal vaginal stimulation.
